(19) United States
(12) Patent Application Publication
(10) Pub. No.: US 2025/0240823 A1
(43) Pub. Date: Jul. 24, 2025

(54) COMMUNICATION BETWEEN RADIO TRANSCEIVER DEVICES VIA A META-SURFACE

(71) Applicant: Telefonaktiebolaget LM Ericsson (publ), Stockholm (SE)

(72) Inventors: Behrooz MAKKI, Pixbo (SE); Jingya LI, Göteborg (SE); Gabor FODOR, Hässelby (SE); André L. F. DE ALMEIDA, FORTALEZA (BR); Francisco H. C. NETO, Fortaleza-CE (BR)

(21) Appl. No.: 18/702,156

(22) PCT Filed: Oct. 21, 2021
(86) PCT No.: PCT/EP2021/079259

§ 371 Date: Apr. 17, 2024

(51) Int. Cl. H04W 74/0833; H04B 7/04

(52) U.S. Cl. CPC H04W 74/0833; H04B 7/04013

(57) ABSTRACT

There is provided mechanisms for communication between radio transceiver devices via meta-surface. A method is performed by a first radio transceiver device. The first radio transceiver device is communicating with a second radio transceiver device via at least one meta-surface over a radio propagation channel. The method comprises performing random access procedures with the second radio transceiver device. Each random access procedure corresponds to a respective activation setting of the at least one meta-surface. The method comprises selecting one of the activation settings for the at least one meta-surface. The method comprises transmitting an indication of the selected activation setting to the second radio transceiver device and a controller of the at least one meta-surface. The method comprises communicating with the second radio transceiver device over the radio propagation channel and via the at least one meta-surface.

### TECHNICAL FIELD

Embodiments presented herein relate to methods, radio transceiver devices, computer programs, and a computer program product for communication between radio transceiver devices vi a meta-surface.

### BACKGROUND

Millimeter waves (mmWaves) corresponding to carrier frequencies above 10 GHz have been introduced for the new radio (NR) air interface as used in fifth generation (5G) telecommunication systems. However, communication over mmWaves, as well as communication over carrier frequencies in lower bands, are sensible to blocking, i.e. physical objects blocking the radio waves.

One technique enabling the creation of smart radio environments involves the use of surfaces that can interact with the radio environment. As disclosed in, for example, “Smart Radio Environments Empowered by AI Reconfigurable Meta-Surfaces: An Idea Whose Time Has Come” by Marco Di Renzo et al., as accessible on https://arxiv.org/abs/1903.08925 (latest accessed 6 Jul. 2021), “Reconfigurable-Intelligent-Surface Empowered Wireless Communications: Challenges and Opportunities” by Xiaojun Yuan et al., as accessible on https://arxiv.org/abs/2001.00364 (latest accessed 6 Jul. 2021), and “Intelligent Reflecting Surface Enhanced Wireless Network via Joint Active and Passive Beamforming” by Q. Wu and R. Zhang, in IEEE Transactions on Wireless Communications, vol. 18, no. 11, pp. 5394-549 November 2019, doi: 10.1109/TWC.2019.2936025 such surfaces are commonly called meta-surfaces, reconfigurable intelligent surfaces, large intelligent surfaces, or intelligent reconfigurable surfaces. Without loss of generality or discrimination between these terms, the term meta-surface will be used throughout this disclosure.

A meta-surface is an electromagnetic surface made of electromagnetic material that is engineered in order to exhibit properties that are not found in naturally occurring materials. A meta-surface is, in practice, an electromagnetic discontinuity, which can be defined as a complex electromagnetic structure that is typically deeply sub-wavelength in thickness, is electrically large in transverse size, and is composed of sub-wavelength scattering particles with extremely small features. In simple terms, a meta-surface is made of a two-dimensional array of sub-wavelength metallic or dielectric scattering particles that transform incoming electromagnetic waves in different ways, thus causing the electromagnetic waves to be reflected in accordance with the structure of the meta-surface.

In further detail, a passive meta-surface is a meta-surface in which the scattering particles or the electromagnetic reflective properties are not fixed and engineered at the manufacturing phase but can be modified depending on external stimuli that is provided to the meta-surface. In this disclosure the external stimuli is defined by a control signal from a reflection node that is operatively connected to the meta-surface. In one example the passive meta-surface consists of arrays of passive patch antennas. That is, the antennas are not connected to active radio transceivers (i.e., devices capable to modulate data streams up to radio frequency and demodulate radio frequencies to data streams). Instead, the antennas in the array are connected to resistors, inductors, and/or capacitors of which the electrical impedance is controllable, and where the antennas are connected to the resistors, inductors, and/or capacitors towards a ground plane such that the reflection phase of respective antenna can be adapted based on electrical impedance setting. Thus, by controlling the electrical impedances of the respective patch antennas, the reflection angle of an incoming electromagnetic wave can be adapted according to the generalized Snell's law. One difference between a regular surface and a passive meta-surface thus lies in the capability of the passive meta-surface of shaping, or reflecting, incoming electromagnetic waves, such as radio waves, according to the generalized Snell's laws of reflection and refraction. For example, the angles of incidence and reflection of the radio waves are not necessarily the same in a passive meta-surface.

Turning now to the user side, before a user equipment can properly communicate with a network, the user equipment commonly must carry out a cell search to find, synchronize and identify a cell served by a network node. Then, the user equipment can acquire basic system information from the network node and perform a random access procedure with the network node to establish a connection to the network node and thus be served in the cell. Two non-limiting examples of random access procedures will be disclosed next, namely contention-based random access and contention-free random access. With contention-based random access, a user equipment randomly selects and sends a random access preamble based on its channel measurements, at the cost of possible contention at the network side. With contention-free random access, on the other hand, the network informs each of the user equipment of exactly when in time each user equipment is to transmit its random access preamble and which random access preamble to use.

A signalling diagram illustrating a contention based random access produce is provided in FIG. 1. In step S1A, a user equipment initiates the random access procedure by transmitting in uplink a random access preamble (Msg 1) on a physical random-access channel (PRACH). After detecting the Msg1, the network node responds in step S2A by transmitting in downlink a random-access response (RAR) in a Msg2 on a physical downlink shared channel (PDSCH). In step S3A, after successfully decoding Msg2, the user equipment continues the random access procedure by transmitting in uplink a Msg3 on a physical uplink shared channel (PUSCH) for terminal identification and radio resource control (RRC) connection establishment request. In step S4A, the network node transmits in downlink Msg4 on PDSCH for contention resolution. A signalling diagram illustrating a contention-free random access produce is provided in FIG. 2. In step S1B the network node transmits a preamble assignment in terms of a PRACH assignment. The user equipment in step S2B responds with a random access preamble (RA-RNTI, where RNTI is short for Radio Network Temporary Identifier) with an indication for protocol layer 2 and layer 3 (L2/L3) message size. The network in step S3B responds with a random access response comprising a timing advance (TA) parameter, a C-RNTI (where C is short for cell), and an uplink (UL) grant for a L2/L3 message.

Existing initial access procedures, such as the two random access procedure disclosed above, do not address any of the above use cases where the user equipment is operatively connected to the network node via a meta-surface. The meta-surface is by itself not provided with any RRC functionalities but only acts as a reflector to change the propagation of radio signals between the network node and the user equipment in a controlled way. This makes it cumbersome to use initial access procedures in such scenarios. Further, although the random access procedures have been exemplified by being performed between a network node and a user equipment, the same issues exist also when other types of radio transceiver devices are to communicate with each other via a meta-surface.

### SUMMARY

An object of embodiments herein is to address the above issues by providing techniques that can be used as part of random access procedures in scenarios where radio transceiver devices are to communicate via a meta-surface.

According to a first aspect there is presented a method for communication between radio transceiver devices vi a meta-surface. The method is performed by a first radio transceiver device. The first radio transceiver device is communicating with a second radio transceiver device via at least one meta-surface over a radio propagation channel. The method comprises performing random access procedures with the second radio transceiver device. Each random access procedure corresponds to a respective activation setting of the at least one meta-surface. The method comprises selecting one of the activation settings for the at least one meta-surface. The method comprises transmitting an indication of the selected activation setting to the second radio transceiver device and a controller of the at least one meta-surface. The method comprises communicating with the second radio transceiver device over the radio propagation channel and via the at least one meta-surface.

According to a second aspect there is presented a first radio transceiver device for communication between radio transceiver devices vi a meta-surface. The first radio transceiver device is configured for communication with a second radio transceiver device via at least one meta-surface over a radio propagation channel. The first radio transceiver device comprises processing circuitry. The processing circuitry is configured to cause the first radio transceiver device to perform random access procedures with the second radio transceiver device. Each random access procedure corresponds to a respective activation setting of the at least one meta-surface. The processing circuitry is configured to cause the first radio transceiver device to select one of the activation settings for the at least one meta-surface. The processing circuitry is configured to cause the first radio transceiver device to transmit an indication of the selected activation setting to the second radio transceiver device and a controller of the at least one meta-surface. The processing circuitry is configured to cause the first radio transceiver device to communicate with the second radio transceiver device over the radio propagation channel and via the at least one meta-surface.

According to a third aspect there is presented a first radio transceiver device for communication between radio transceiver devices vi a meta-surface. The first radio transceiver device is configured for communication with a second radio transceiver device via at least one meta-surface over a radio propagation channel. The first radio transceiver device comprises a random access module configured to perform random access procedures with the second radio transceiver device. Each random access procedure corresponds to a respective activation setting of the at least one meta-surface. The first radio transceiver device comprises a select module configured to select one of the activation settings for the at least one meta-surface. The first radio transceiver device comprises a transmit module configured to transmit an indication of the selected activation setting to the second radio transceiver device and a controller of the at least one meta-surface. The first radio transceiver device comprises a communication module configured to communicate with the second radio transceiver device over the radio propagation channel and via the at least one meta-surface.

According to a fourth aspect there is presented a computer program for communication between radio transceiver devices vi a meta-surface, the computer program comprising computer program code which, when run on processing circuitry of a first radio transceiver device, causes the first radio transceiver device to perform a method according to the first aspect.

According to a fifth aspect there is presented a method for communication between radio transceiver devices via a meta-surface. The method is performed by a second radio transceiver device. The second radio transceiver device is communicating with a first radio transceiver device via at least one meta-surface over a radio propagation channel. The method comprises performing random access procedures with the first radio transceiver device. Each random access procedure corresponds to a respective activation setting of the at least one meta-surface. The method comprises obtaining, for each of the activation settings, initial uplink transmission parameters for the second radio transceiver device to use when communicating with the first radio transceiver device over the radio propagation channel and via the at least one meta-surface. The method comprises receiving an indication of a selected activation setting from the first radio transceiver device. The method comprises communicating with the first radio transceiver device over the radio propagation channel and via the at least one meta-surface whilst applying the initial uplink transmission parameters that correspond to the selected activation setting.

According to a sixth aspect there is presented a second radio transceiver device for communication between radio transceiver devices vi a meta-surface. The second radio transceiver device is configured for communication with a first radio transceiver device via at least one meta-surface over a radio propagation channel. The second radio transceiver device comprises processing circuitry. The processing circuitry is configured to cause the second radio transceiver device to perform random access procedures with the first radio transceiver device. Each random access procedure corresponds to a respective activation setting of the at least one meta-surface. The processing circuitry is configured to cause the second radio transceiver device to obtain, for each of the activation settings, initial uplink transmission parameters for the second radio transceiver device to use when communicating with the first radio transceiver device over the radio propagation channel and via the at least one meta-surface. The processing circuitry is configured to cause the second radio transceiver device to receive an indication of a selected activation setting from the first radio transceiver device. The processing circuitry is configured to cause the second radio transceiver device to communicate with the first radio transceiver device over the radio propagation channel and via the at least one meta-surface whilst applying the initial uplink transmission parameters that correspond to the selected activation setting.

According to a seventh aspect there is presented a second radio transceiver device for communication between radio transceiver devices vi a meta-surface. The second radio transceiver device is configured for communication with a first radio transceiver device via at least one meta-surface over a radio propagation channel. The second radio transceiver device comprises a random access module configured to perform random access procedures with the first radio transceiver device. Each random access procedure corresponds to a respective activation setting of the at least one meta-surface. The second radio transceiver device comprises an obtain module configured to obtain, for each of the activation settings, initial uplink transmission parameters for the second radio transceiver device to use when communicating with the first radio transceiver device over the radio propagation channel and via the at least one meta-surface. The second radio transceiver device comprises a receive module configured to receive an indication of a selected activation setting from the first radio transceiver device. The second radio transceiver device comprises a communicate module configured to communicate with the first radio transceiver device over the radio propagation channel and via the at least one meta-surface whilst applying the initial uplink transmission parameters that correspond to the selected activation setting.

According to an eighth aspect there is presented a computer program for communication between radio transceiver devices vi a meta-surface, the computer program comprising computer program code which, when run on processing circuitry of a second radio transceiver device, causes the second radio transceiver device to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects can be used to resolve the above issues that otherwise can occur when random access procedures are performed in scenarios where radio transceiver devices are to communicate via a meta-surface.

Advantageously, these aspects enable data transmission in meta-surface assisted networks to be adapted, where the radio transceiver devices can quickly adapt their transmission and reception parameters based on the configuration, as given by the selected activation setting, of the meta-surfaces.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1 and 2 are signalling diagrams according to examples;

FIG. 3 is a schematic diagram illustrating a communications network according to embodiments;

FIGS. 4 and 5 are flowcharts of methods according to embodiments;

FIG. 6 is a schematic diagram showing functional units of a first radio transceiver device according to an embodiment;

FIG. 7 is a schematic diagram showing functional modules of a first radio transceiver device according to an embodiment;

FIG. 8 is a schematic diagram showing functional units of a second radio transceiver device according to an embodiment;

FIG. 9 is a schematic diagram showing functional modules of a second radio transceiver device according to an embodiment; and

FIG. 10 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

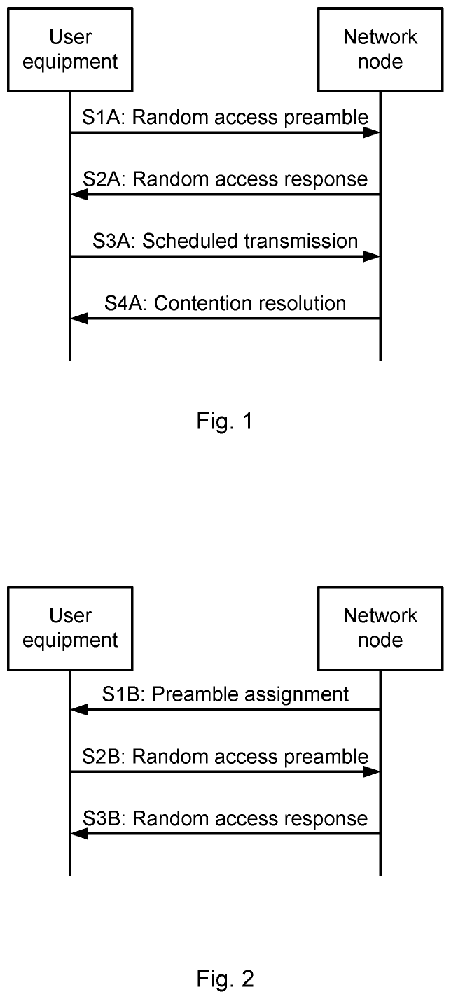

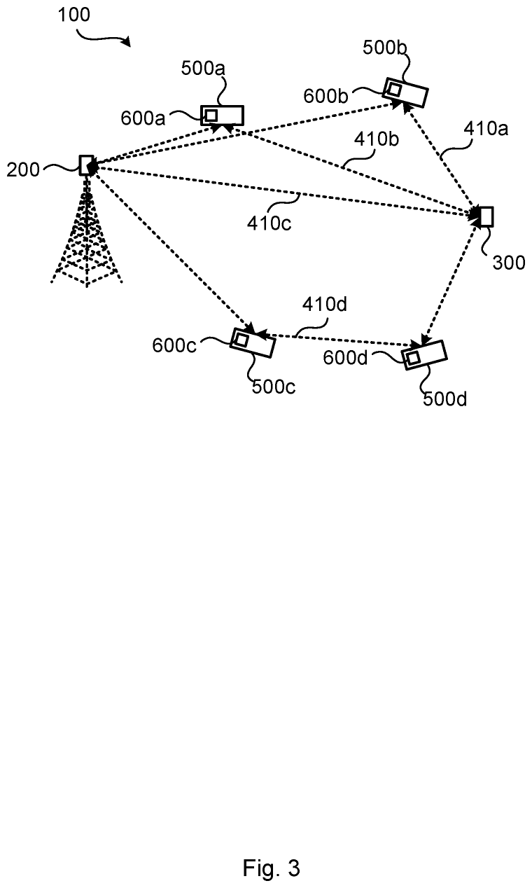

FIG. 1 is a schematic diagram illustrating a communications network 100 where embodiments presented herein can be applied. The communications network 100 comprises a first radio transceiver device 200 and a second radio transceiver device 300. In some non-limiting examples, the first radio transceiver device 200 is, is operatively connected to, or is integrated with, an access network node and the second radio transceiver device 300 is, is operatively connected to, or is integrated with, a user equipment served by the access network node. In other non-limiting examples, the first radio transceiver device 200 is, is operatively connected to, or is integrated with, a parent integrated access and backhaul (IAB) node and the second radio transceiver device 300 is, is operatively connected to, or is integrated with, a child IAB node to the parent IAB node.

The communications network 100 further comprises meta-surfaces 500a, 500b, 500vc, 500d. Each meta-surface 500a: 500d is illustrated to be controlled by its own controller 600a, 600b, 600c, 600d. However, it could be that one controller 600a: 600d is configured to control more than one of the meta-surfaces 500a: 500d. In some examples, the meta-surfaces 500a: 500d are statically deployed, possibly for boosting the spectrum and energy efficiency of the communications network 100. The locations of the meta-surfaces 500a: 500d might be optimized based on estimated traffic load and/or, e.g., blockages/tree foliage.

The first radio transceiver device 200 and the second radio transceiver device 300 are configured to selectively communicate with each other along different radio paths 410a, 410b, 410c, 410d. As an example, radio path 410c is a direct path between the first radio transceiver device 200 and the second radio transceiver device 300, and radio path 410d is a radio path between the first radio transceiver device 200 and the second radio transceiver device 300 via meta-surface 500c and meta-surface 500d. Consider radio path 410a in FIG. 1, the signal received at the first radio transceiver device 200 from the second radio transceiver device 300 is given by

$$Y = \sqrt{{P}_{T 2}} {h}_{M - T 1}^{H} Φ {h}_{T 2 - M} + z .$$

Here, z is represents additive noise at the first radio transceiver device 200, h_{M-TS1}^{H} and h_{TS2-M} are the channel gain between meta-surface 500b and the first radio transceiver device 200 and the channel gain between the second radio transceiver device 300 and meta-surface 500b, respectively, and @ is a phase value matrix at meta-surface 500b, and P_{T2} is the transmission power of the second radio transceiver device 300.

As disclosed above there are some scenarios where it is cumbersome to perform random access procedures when communicating via a meta-surface 500a: 500d. In particular, when meta-surfaces 500a: 500d are deployed in the coverage area, the radio transceiver devices might lack information about the configuration of the deployed meta-surfaces 500a: 500d prior to connection establishment, or at least how the configurations affect the radio environment, and thus the radio paths 410a: 410d, and therefore the proper initial uplink transmission parameters and reception parameters cannot be properly configured.

The embodiments disclosed herein thus relate to mechanisms for communication between radio transceiver devices vi a meta-surface 500a: 500d. In order to obtain such mechanisms there is provided a first radio transceiver device 200, a method performed by the first radio transceiver device 200, a computer program product comprising code, for example in the form of a computer program, that when run on processing circuitry of the first radio transceiver device 200, causes the first radio transceiver device 200 to perform the method. In order to obtain such mechanisms there is further provided a second radio transceiver device 300, a method performed by the second radio transceiver device 300, and a computer program product comprising code, for example in the form of a computer program, that when run on processing circuitry of the second radio transceiver device 300, causes the second radio transceiver device 300 to perform the method.

In some aspects, techniques are disclosed for at least one of the radio transceiver devices to obtain a set of initial uplink transmission parameters using random access procedures. These initial uplink transmission parameters can be stored by at least one of the radio transceiver devices and be made accessible for the second radio transceiver device 300 such that, if necessary, the first radio transceiver device 200 can quickly switch between different radio paths/meta-surfaces 500a: 500d (in accordance with activation settings selected by the first radio transceiver device 200) so that the second radio transceiver device 300 can apply the most appropriate initial uplink transmission parameters when communicating with the first radio transceiver device 200 via at least one of the meta-surfaces 500a: 500d.

Multiple random access procedures might therefore be performed by the second radio transceiver device 300 with respect to the first radio transceiver device 200, where each random access procedure corresponds to a specific activation setting. Examples of such activation settings will be provided below. For each performed random access procedure, one or more of the meta-surfaces 500a: 500d may become active, and the second radio transceiver device 300 (and/or the first radio transceiver device 200) obtains and stores the associated initial uplink transmission parameters. Examples of such initial uplink transmission parameters will be provided below. Then, during data transmission, the first radio transceiver device 200 might switch between different activation settings, and signal this to the second radio transceiver device 300 as well as to a a 600a: 600d of the meta-surfaces 500a: 500d, based on current traffic load, quality of service (QOS) requirements, etc. The second radio transceiver device 300 can then apply the corresponding initial uplink transmission parameters when communicating with the first radio transceiver device 200 via at least one of the meta-surfaces 500a: 500d. Multiple radio paths (one for each activation setting) in the radio environment might thereby be tried one by one, and the activation setting corresponding to the best radio path can be based on some end-to-end performance criterion.

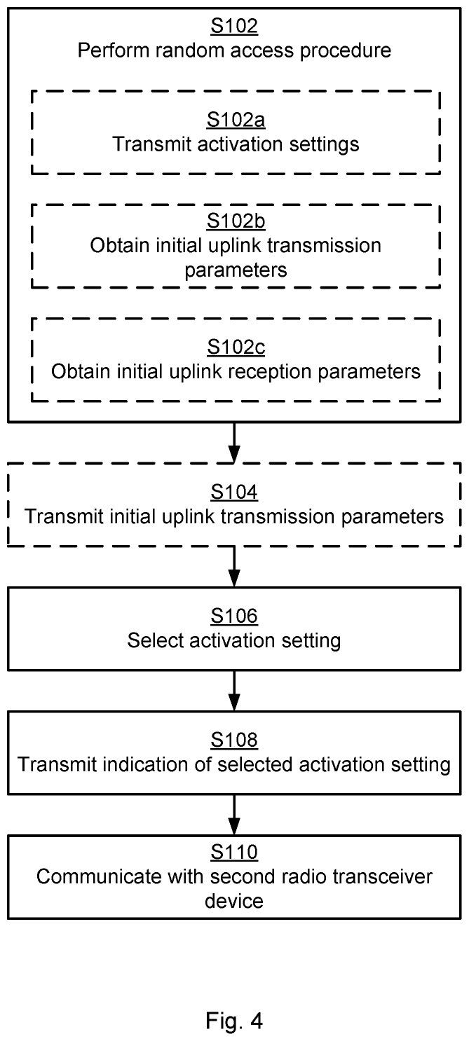

Reference is now made to FIG. 4 illustrating a method for communication between radio transceiver devices vi a meta-surface 500a: 500d as performed by the first radio transceiver device 200 according to an embodiment. The first radio transceiver device 200 is communicating with a second radio transceiver device 300 via at least one meta-surface 500a: 500d over a radio propagation channel.

S102: The first radio transceiver device 200 performs random access procedures with the second radio transceiver device 300. Each random access procedure corresponds to a respective activation setting of the at least one meta-surface 500a: 500d. In this respect, it is assumed that there are at least two settings of the at least one meta-surface 500a: 500d and hence at least two random access procedures are performed by the first radio transceiver device 200 with the second radio transceiver device 300.

S106: The first radio transceiver device 200 selects one of the activation settings for the at least one meta-surface 500a: 500d.

S108: The first radio transceiver device 200 transmits an indication of the selected activation setting to the second radio transceiver device 300 and a controller 600a: 600d of the at least one meta-surface 500a: 500d.

S110: The first radio transceiver device 200 communicates with the second radio transceiver device 300 over the radio propagation channel and via the at least one meta-surface 500a: 500d.

Embodiments relating to further details of communication between radio transceiver devices vi a meta-surface 500a: 500d as performed by the first radio transceiver device 200 will now be disclosed.

Aspects of how the indication of the selected activation setting might be transmitted to the second radio transceiver device 300 will be disclosed next.

In some examples, the indication of the selected activation setting is transmitted to the second radio transceiver device 300 using any of: cell-specific radio resource control (RRC) signaling, device specific RRC signaling, or downlink control information (DCI) signaling. The indication can thereby be included in the control signaling used by the first radio transceiver device 200 for scheduling its data transmission and/or reception.

In some examples, the indication of the selected activation setting is transmitted as a single parameter value that has a one-to-one mapping to the selected activation setting. The indication can thus be provided as a parameter, whose values have a one-to-one mapping to the activation settings. The second radio transceiver device 300 then either needs to know all the available activation settings in advance, or the order in which the different activation settings were used during the random access procedures. For instance, consider a non-limiting example of two meta-surfaces 500a: 500b, the indication can then be provided as a parameter that takes four values with a mapping according to Table 1.

TABLE 1
Example of mapping between parameter
values and activation settings

| Parameter | |
|---|---|
| value | Activation setting |
| 0 | No meta-surface activated |
| 1 | Only meta-surface 500a activated |
| 2 | Only meta-surface 500a activated |
| 3 | Both meta-surfaces 500a and 500b activated |
| . . . | . . . |

In other examples, the indication of the selected activation setting as transmitted is the selected activation setting itself. The second radio transceiver device 300 then needs to know to which initial uplink transmission parameters the selected activation setting corresponds to. Such a mapping could be provided to the second radio transceiver device 300 from the first radio transceiver device 200 as in S102a below.

In general terms, the same principle can be applied for the first radio transceiver device 200 to transmit the activation settings to the controller 600a: 600d, except that the activation settings are transmitted over a control channel established between the first radio transceiver device 200 and the controller 600a: 600d.

The different available activation settings from which the activation setting in S106 is selected, might also be signalled to the controller 600a: 600d of the meta-surface 500a: 500d and, possible, also the second radio transceiver device 300. Hence, in some embodiments, the first radio transceiver device 200 is configured to perform (optional) step S102a as part of performing the random access procedures in S102:

S102a: The first radio transceiver device 200 transmits the activation settings to the second radio transceiver device 300 and the controller 600a: 600d of the meta-surface 500a: 500d in advance of, or whilst performing, the random access procedures.

In general terms, the activation settings might be transmitted to the second radio transceiver device 300 using any of: cell-specific RRC signaling, device specific RRC signaling, or DCI signaling.

In general terms, the activation settings might be transmitted to the controller 600a: 600d over a control channel established between the first radio transceiver device 200 and the controller 600a: 600d.

As disclosed above, there could be different examples of activation settings. In some non-limiting examples, the activation settings concerns on-and-off switching of the meta-surfaces 500a: 500d. That is, the activation settings might pertain to each individual of the at least one meta-surface 500a: 500d being switched on or switched off. In some non-limiting examples, the activation settings concerns select of phase shift values at the meta-surfaces 500a: 500d. That is, the at least one meta-surface 500a: 500d might comprises reflective elements having a respective phase shift value, and each of the activation settings might pertain to settings of the phase shift values. Hence, the activation settings might pertain to whether a given meta-surface 500a: 500d is switched on or switched off, and/or which phase shift values that should be applied at a given meta-surface 500a: 500d to provide proper network performance.

As disclosed above, the second radio transceiver device 300 (and/or the first radio transceiver device 200) obtains and stores the associated initial uplink transmission parameters. That is, in some aspects, the initial uplink transmission parameters are obtained by the first radio transceiver device 200 and then signalled to the second radio transceiver device 300. Hence, in some embodiments, the first radio transceiver device 200 is configured to perform (optional) step S102b as part of performing the random access procedures in S102:

S102b: The first radio transceiver device 200 obtains, for each of the activation settings and whilst performing the random access procedures, initial uplink transmission parameters for the second radio transceiver device 300 to use when communicating with the first radio transceiver device 200 over the radio propagation channel and via the at least one meta-surface 500a: 500d.

The initial uplink transmission parameters are then provided to the second radio transceiver device 300 so that the second radio transceiver device 300 can apply the initial uplink transmission parameters. Hence, in some embodiments, the first radio transceiver device 200 is configured to perform (optional) step S104:

S104: The first radio transceiver device 200 transmits the initial uplink transmission parameters for each of the activation settings to the second radio transceiver device 300 before communicating with the second radio transceiver device 300.

As disclosed above, there could be different examples of initial uplink transmission parameters. In some non-limiting examples, the initial uplink transmission parameters pertain to at least one of: timing advance value, beamforming parameters, transmit power parameters, PRACH preamble format, and/or time resources, frequency resources, to be used by the second radio transceiver device 300.

In further aspects, initial uplink reception parameters for the first radio transceiver device 200 are obtained. As for the initial uplink transmission parameters for the second radio transceiver device 300, also the initial uplink reception parameters for the first radio transceiver device 200 can be obtained directly by the first radio transceiver device 200 or first be obtained by the second radio transceiver device 300 and the signalled to the first radio transceiver device 200. Particularly, in some embodiments, the first radio transceiver device 200 is configured to perform (optional) step S102c as part of performing the random access procedures in S102:

S102c: The first radio transceiver device 200 obtains, for each of the activation settings and whilst performing the random access procedures, initial uplink reception parameters for the first radio transceiver device 200 to use when communicating with the second radio transceiver device 300 over the radio propagation channel and via the at least one meta-surface 500a: 500d.

In some non-limiting examples, the initial uplink reception parameters pertain to at least one of: timing value, beamforming parameters, transmit power parameters, PRACH preamble format, time resources, frequency resources, to be used by the first radio transceiver device 300.

There could be different examples of parameters based on which the selection of the activation setting is made in S106. In some non-limiting examples, the activation settings that is selected based on at least one of: traffic load level of the first radio transceiver device 200, quality of service requirements of the second radio transceiver device 300.

Further in this respect, in some examples, the maximum number of considered activation setting is pre-determined, for example based on latency constraints. This could be the case where there is a comparatively large number of available activation settings for the first radio transceiver device 200 to select from. This would also limit the total number of random access procedures performed in S102. Hence, the number of activation settings to test, and thus the number of random access procedures to be performed in S102, might be a function of a latency requirement for the communication between the first radio transceiver device 300 and the second radio transceiver device 300.

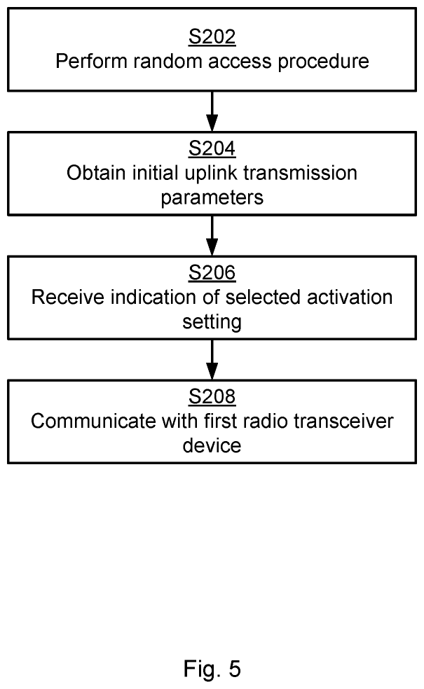

Reference is now made to FIG. 5 illustrating a method for communication between radio transceiver devices vi a meta-surface 500a: 500d as performed by the second radio transceiver device 300 according to an embodiment. In general terms, the embodiments, aspects, and examples as disclosed above with reference to the methods performed by the first radio transceiver device 200 apply also to the method performed by the second radio transceiver device 300. The second radio transceiver device 300 is thus assumed to be communicating with the first radio transceiver device 200 via at least one meta-surface 500a: 500d over a radio propagation channel.

S202: The second radio transceiver device 300 performs random access procedures with the first radio transceiver device 200. As disclosed above, each random access procedure corresponds to a respective activation setting of the at least one meta-surface 500a: 500d. As further follows from above, at least two random access procedures are performed by the second radio transceiver device 300 with the first radio transceiver device 200.

S204: The second radio transceiver device 300 obtains, for each of the activation settings, initial uplink transmission parameters for the second radio transceiver device 300 to use when communicating with the first radio transceiver device 200 over the radio propagation channel and via the at least one meta-surface 500a: 500d.

As disclosed above, the first radio transceiver device 200 transmits an indication of a selected activation setting to the second radio transceiver device 300. It is assumed that this indication is received by the second radio transceiver device 300.

S206: The second radio transceiver device 300 thus receives an indication of a selected activation setting from the first radio transceiver device 200.

The initial uplink transmission parameters that correspond to the selected activation setting are then used by the second radio transceiver device 300.

S208: The second radio transceiver device 300 communicates with the first radio transceiver device 200 over the radio propagation channel and via the at least one meta-surface 500a: 500d whilst applying the initial uplink transmission parameters that correspond to the selected activation setting.

Embodiments relating to further details of communication between radio transceiver devices vi a meta-surface 500a: 500d as performed by the second radio transceiver device 300 will now be disclosed.

As disclosed above, the second radio transceiver device 300 (and/or the first radio transceiver device 200) obtains and stores the associated initial uplink transmission parameters. That is, in some aspects, the initial uplink transmission parameters are obtained by the second radio transceiver device 300. Hence, in some embodiments, the initial uplink transmission parameters are obtained by the second radio transceiver device 300 whilst performing the random access procedures. In other embodiments, the initial uplink transmission parameters are obtained by being received from the first radio transceiver device 200 upon the random access procedures having been performed.

As disclosed above, in some non-limiting examples, the initial uplink transmission parameters pertain to at least one of: timing advance value, beamforming parameters, transmit power parameters, PRACH preamble format, time resources, frequency resources, to be used by the second radio transceiver device 300.

Examples of how the indication of the selected activation setting might be transmitted to the second radio transceiver device 300 have been disclosed above. In corresponding non-limiting examples, the indication of the selected activation setting might thus be received from the first radio transceiver device 200 using any of: cell-specific RRC signaling, device specific RRC signaling, or DCI, signaling.

As further disclosed above, in some examples, the indication of the selected activation setting might be transmitted as a single parameter value that has a one-to-one mapping to the selected activation setting. That is, the indication of the selected activation setting might be received as a single parameter value that has a one-to-one mapping to the selected activation setting.

As further disclosed above, in other examples, the indication of the selected activation setting as transmitted is the selected activation setting itself. That is, the indication of the selected activation setting as received might thus be the selected activation setting itself.

A non-limiting example taking advantage of at least some of the herein disclosed embodiments, aspects, and examples will be provided next.

S301: A first random access procedure is performed between the first radio transceiver device 200 and the second radio transceiver device 300 whilst all the meta-surface 500a: 500d are switched off. Associated initial uplink transmission parameters, such as timing advance value, beamforming setting, and appropriate transmit power, etc. are stored.

S302: Depending on the number of available activation settings, such as number of available meta-surface 500a: 500d and number of available phase shift settings of each meta-surface 500a: 500d, multiple random access procedure for different activation settings are performed. For each activation setting the first radio transceiver device 200 might signal the activation setting to the controllers 600a: 600d so that the controllers 600a: 600d can configure the meta-surfaces 500a: 500d accordingly. One random access procedure is then performed between the first radio transceiver device 200 and the second radio transceiver device 300 for each of the activation settings. Associated initial uplink transmission parameters, such as timing advance value, beamforming setting, and appropriate transmit power, etc. are stored for each random access procedure (i.e., for each of the activation settings).

S303: During the data transmission form the first radio transceiver device 200, depending on the considered, possibly meta-surface assisted, radio path, the second radio transceiver device 300 and the controllers 600a: 600d of the involved meta-surfaces 500a: 500d are informed of the selected activation setting to adapt their parameters accordingly.

As above, with regards to S302, it is possible that the first radio transceiver device 200 signals all possible/considered activation settings and the corresponding random access configuration(s) to the second radio transceiver device 300 before the random access procedures are performed in S302. The second radio transceiver device 300 might then perform the random access procedures in a sequential way based on the received signaling.

Accordingly, the proposed embodiments enable fast adaptive of activation settings in meta surface assisted networks and make it possible to perform fast uplink synchronization when switching to a different activation setting for data transmission. Also, the preferred, and later selected, meta-surface configurations (as defined by the activation settings) are determined during the random access procedure.

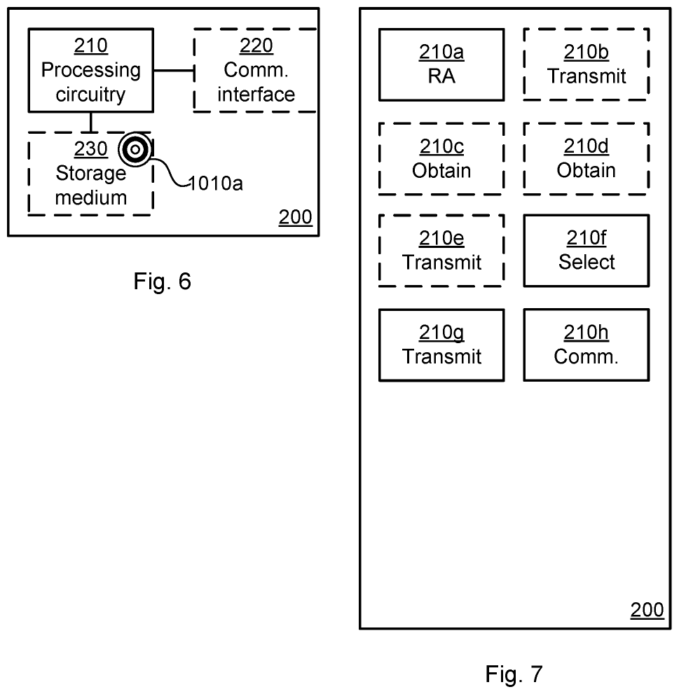

FIG. 6 schematically illustrates, in terms of a number of functional units, the components of a first radio transceiver device 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1010a (as in FIG. 10), e.g. in the form of a storage medium 230. The processing circuitry 210 may further be provided as at least one application specific integrated circuit (ASIC), or field programmable gate array (FPGA).

Particularly, the processing circuitry 210 is configured to cause the first radio transceiver device 200 to perform a set of operations, or steps, as disclosed above. For example, the storage medium 230 may store the set of operations, and the processing circuitry 210 may be configured to retrieve the set of operations from the storage medium 230 to cause the first radio transceiver device 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The first radio transceiver device 200 may further comprise a communications interface 220 for communications with other entities, functions, nodes and devices, as in FIG. 1. As such the communications interface 220 may comprise one or more transmitters and receivers, comprising analogue and digital components.

The processing circuitry 210 controls the general operation of the first radio transceiver device 200 e.g. by sending data and control signals to the communications interface 220 and the storage medium 230, by receiving data and reports from the communications interface 220, and by retrieving data and instructions from the storage medium 230. Other components, as well as the related functionality, of the first radio transceiver device 200 are omitted in order not to obscure the concepts presented herein.

FIG. 7 schematically illustrates, in terms of a number of functional modules, the components of a first radio transceiver device 200 according to an embodiment. The first radio transceiver device 200 of FIG. 7 comprises a number of functional modules; a random access (RA) module 210a configured to perform step S102, a select module 210f configured to perform step S106, a transmit module 210g configured to perform step S108, and a communicate module 210h configured to perform step S110. The first radio transceiver device 200 of FIG. 7 may further comprise a number of optional functional modules, such as any of a transmit module 210b configured to perform step S102a, an obtain module 210c configured to perform step S102b, an obtain module 210d configured to perform step S102c, and a transmit module configured to perform step S104. In general terms, each functional module 210a: 210h may be implemented in hardware or in software. Preferably, one or more or all functional modules 210a: 210h may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210h and to execute these instructions, thereby performing any steps of the first radio transceiver device 200 as disclosed herein.

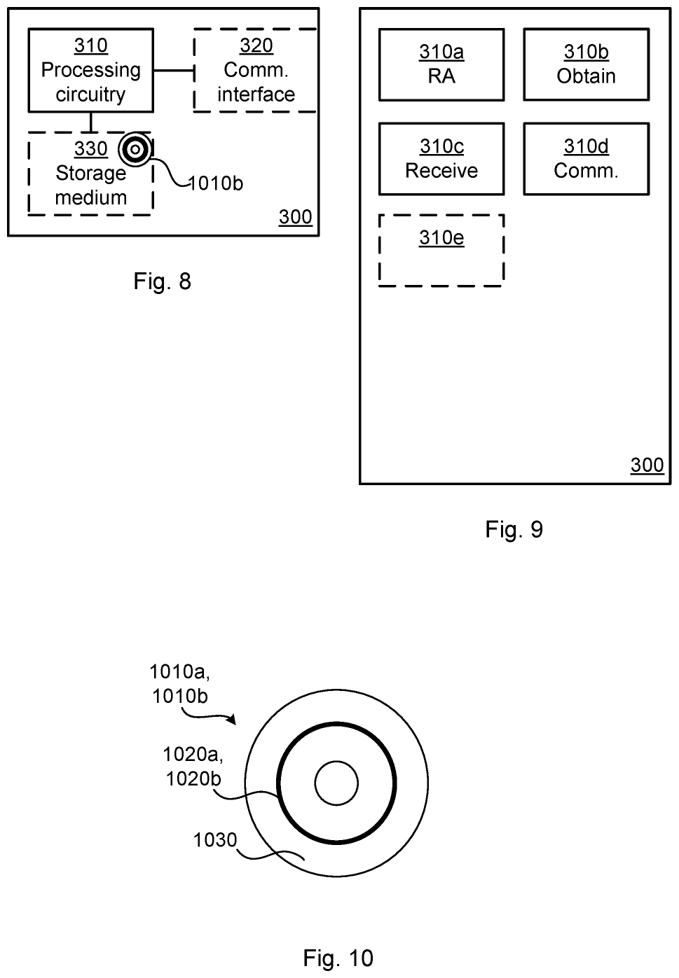

FIG. 8 schematically illustrates, in terms of a number of functional units, the components of a second radio transceiver device 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1010b (as in FIG. 10), e.g. in the form of a storage medium 330. The processing circuitry 310 may further be provided as at least one application specific integrated circuit (ASIC), or field programmable gate array (FPGA).

Particularly, the processing circuitry 310 is configured to cause the second radio transceiver device 300 to perform a set of operations, or steps, as disclosed above. For example, the storage medium 330 may store the set of operations, and the processing circuitry 310 may be configured to retrieve the set of operations from the storage medium 330 to cause the second radio transceiver device 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The second radio transceiver device 300 may further comprise a communications interface 320 for communications with other entities, functions, nodes and devices, as in FIG. 1. As such the communications interface 320 may comprise one or more transmitters and receivers, comprising analogue and digital components.

The processing circuitry 310 controls the general operation of the second radio transceiver device 300 e.g. by sending data and control signals to the communications interface 320 and the storage medium 330, by receiving data and reports from the communications interface 320, and by retrieving data and instructions from the storage medium 330. Other components, as well as the related functionality, of the second radio transceiver device 300 are omitted in order not to obscure the concepts presented herein.

FIG. 9 schematically illustrates, in terms of a number of functional modules, the components of a second radio transceiver device 300 according to an embodiment. The second radio transceiver device 300 of FIG. 9 comprises a number of functional modules; a rando access (RA) module 310a configured to perform step S202, an obtain module 310b configured to perform step S204, a receive module 310c configured to perform step S206, and a communicate module 310d configured to perform step S208. The second radio transceiver device 300 of FIG. 9 may further comprise a number of optional functional modules, as represented by functional module 310e. In general terms, each functional module 310a: 310e may be implemented in hardware or in software. Preferably, one or more or all functional modules 310a: 310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a: 310e and to execute these instructions, thereby performing any steps of the second radio transceiver device 300 as disclosed herein.

The first radio transceiver device 200 and/or second radio transceiver device 300 may be provided as a standalone device or as a part of at least one further device. Thus, a first portion of the instructions performed by the first radio transceiver device 200 and/or second radio transceiver device 300 may be executed in a first device, and a second portion of the instructions performed by the first radio transceiver device 200 and/or second radio transceiver device 300 may be executed in a second device; the herein disclosed embodiments are not limited to any particular number of devices on which the instructions performed by the first radio transceiver device 200 and/or second radio transceiver device 300 may be executed. Hence, the methods according to the herein disclosed embodiments are suitable to be performed by a first radio transceiver device 200 and/or second radio transceiver device 300 residing in a cloud computational environment. Therefore, although a single processing circuitry 210, 310 is illustrated in FIGS. 6 and 8 the processing circuitry 210, 310 may be distributed among a plurality of devices, or nodes. The same applies to the functional modules 210a: 210h, 310a: 310e of FIGS. 7 and 9 and the computer programs 1020a, 1020b of FIG. 10.

FIG. 10 shows one example of a computer program product 1010a, 1010b comprising computer readable means 1030. On this computer readable means 1030, a computer program 1020a can be stored, which computer program 1020a can cause the processing circuitry 210 and thereto operatively coupled entities and devices, such as the communications interface 220 and the storage medium 230, to execute methods according to embodiments described herein. The computer program 1020a and/or computer program product 1010a may thus provide means for performing any steps of the first radio transceiver device 200 as herein disclosed. On this computer readable means 1030, a computer program 1020b can be stored, which computer program 1020b can cause the processing circuitry 310 and thereto operatively coupled entities and devices, such as the communications interface 320 and the storage medium 330, to execute methods according to embodiments described herein. The computer program 1020b and/or computer program product 1010b may thus provide means for performing any steps of the second radio transceiver device 300 as herein disclosed.

In the example of FIG. 10, the computer program product 1010a, 1010b is illustrated as an optical disc, such as a CD (compact disc) or a DVD (digital versatile disc) or a Blu-Ray disc. The computer program product 1010a, 1010b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020a, 1020b is here schematically shown as a track on the depicted optical disk, the computer program 1020a, 1020b can be stored in any way which is suitable for the computer program product 1010a, 1010b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for communication between radio transceiver devices via a meta-surface, the method being performed by a first radio transceiver device, the first radio transceiver device communicating with a second radio transceiver device via at least one meta-surface over a radio propagation channel, the method comprising:
performing random access procedures with the second radio transceiver device, wherein each random access procedure corresponds to a respective activation setting of the at least one meta-surface;
selecting one of the activation settings for the at least one meta-surface;
transmitting an indication of the selected activation setting to the second radio transceiver device and a controller of the at least one meta-surface; and
communicating with the second radio transceiver device over the radio propagation channel and via the at least one meta-surface.

2. The method according to claim 1, wherein the method further comprises:
obtaining, for each of the activation settings and while performing the random access procedures, initial uplink transmission parameters for the second radio transceiver device to use when communicating with the first radio transceiver device over the radio propagation channel and via the at least one meta-surface; and
transmitting the initial uplink transmission parameters for each of the activation settings to the second radio transceiver device before communicating with the second radio transceiver device.

3. (canceled)

4. The method according to claim 1, wherein the method further comprises:
obtaining, for each of the activation settings and while performing the random access procedures, initial uplink reception parameters for the first radio transceiver device to use when communicating with the second radio transceiver device over the radio propagation channel and via the at least one meta-surface.

5. The method according to claim 4, wherein the initial uplink reception parameters pertain to at least one of: timing value, beamforming parameters, transmit power parameters, PRACH preamble format, time resources, frequency resources.

6. The method according to claim 1, wherein the method further comprises:
transmitting the activation settings to the second radio transceiver device and the controller of the meta-surface in advance of, or while performing, the random access procedures.

7. The method according to claim 1, wherein the indication of the selected activation setting is transmitted to the second radio transceiver device using any of: cell-specific radio resource control, RRC, signaling, device specific RRC signaling, downlink control information, DCI, signaling.

8. The method according to claim 1, wherein the indication of the selected activation setting is transmitted as a single parameter value that has a one-to-one mapping to the selected activation setting.

9. The method according to claim 1, wherein the indication of the selected activation setting as transmitted is the selected activation setting itself.

10. The method according to claim 1, wherein the activation settings pertain to each individual of the at least one meta-surface-being switched on or switched off.

11. The method according to claim 1, wherein the at least one meta-surface comprises reflective elements having a respective phase shift value, and wherein each of the activation settings pertain to settings of the phase shift values.

12. The method according to claim 1, wherein said one of the activation settings is selected based on at least one of: traffic load level of the first radio transceiver device, quality of service requirements of the second radio transceiver device.

13-14. (canceled)

15. A method for communication between radio transceiver devices via a meta-surface, the method being performed by a second radio transceiver device, the second radio transceiver device communicating with a first radio transceiver device via at least one meta-surface over a radio propagation channel, the method comprising:
performing random access procedures with the first radio transceiver device, wherein each random access procedure corresponds to a respective activation setting of the at least one meta-surface;
obtaining, for each of the activation settings, initial uplink transmission parameters for the second radio transceiver device to use when communicating with the first radio transceiver device over the radio propagation channel and via the at least one meta-surface;
receiving an indication of a selected activation setting from the first radio transceiver device; and
communicating with the first radio transceiver device over the radio propagation channel and via the at least one meta-surface whilst applying the initial uplink transmission parameters that correspond to the selected activation setting.

16. The method according to claim 15, wherein the initial uplink transmission parameters are obtained by the second radio transceiver device while performing the random access procedures.

17. The method according to claim 15, wherein the initial uplink transmission parameters are obtained by being received from the first radio transceiver device upon the random access procedures having been performed.

18-19. (canceled)

20. The method according to claim 15, wherein the indication of the selected activation setting is received as a single parameter value that has a one-to-one mapping to the selected activation setting.

21. The method according to claim 15, wherein the indication of the selected activation setting as received is the selected activation setting itself.

22-23. (canceled)

24. A first radio transceiver device for communication between radio transceiver devices via a meta-surface, the first radio transceiver device being configured for communication with a second radio transceiver device via at least one meta-surface over a radio propagation channel, the first radio transceiver device comprising processing circuitry, the processing circuitry being configured to cause the first radio transceiver device to:
perform random access procedures with the second radio transceiver device, wherein each random access procedure corresponds to a respective activation setting of the at least one meta-surface;
select one of the activation settings for the at least one meta-surface;
transmit an indication of the selected activation setting to the second radio transceiver device and a controller of the at least one meta-surface; and
communicate with the second radio transceiver device over the radio propagation channel and via the at least one meta-surface.

25-26. (canceled)

27. A second radio transceiver device for communication between radio transceiver devices via a meta-surface, the second radio transceiver device being configured for communication with a first radio transceiver device via at least one meta-surface over a radio propagation channel, the second radio transceiver device comprising processing circuitry, the processing circuitry being configured to cause the second radio transceiver device to:
perform random access procedures with the first radio transceiver device, wherein each random access procedure corresponds to a respective activation setting of the at least one meta-surface;
obtain, for each of the activation settings, initial uplink transmission parameters for the second radio transceiver device to use when communicating with the first radio transceiver device over the radio propagation channel and via the at least one meta-surface;
receive an indication of a selected activation setting from the first radio transceiver device; and
communicate with the first radio transceiver device over the radio propagation channel and via the at least one meta-surface whilst applying the initial uplink transmission parameters that correspond to the selected activation setting.

28-29. (canceled)

30. A computer program product for communication between radio transceiver devices via a meta-surface, the computer program product comprising a non-transitory computer readable medium storing a computer program comprising computer code which, when run on processing circuitry of a first radio transceiver device configured for communication with a second radio transceiver device via at least one meta-surface over a radio propagation channel, causes the first radio transceiver device to:
perform random access procedures with the second radio transceiver device, wherein each random access procedure corresponds to a respective activation setting of the at least one meta-surface;
select one of the activation settings for the at least one meta-surface;
transmit an indication of the selected activation setting to the second radio transceiver device and a controller of the at least one meta-surface; and
communicate with the second radio transceiver device over the radio propagation channel and via the at least one meta-surface.

31. A computer program product for communication between radio transceiver devices via a meta-surface, the computer program product comprising a non-transitory computer readable medium storing a computer program comprising computer code which, when run on processing circuitry of a second radio transceiver device configured for communication with a first radio transceiver device via at least one meta-surface over a radio propagation channel, causes the second radio transceiver device to:
perform random access procedures with the first radio transceiver device, wherein each random access procedure corresponds to a respective activation setting of the at least one meta-surface;
obtain, for each of the activation settings, initial uplink transmission parameters for the second radio transceiver device to use when communicating with the first radio transceiver device over the radio propagation channel and via the at least one meta-surface;
receive an indication of a selected activation setting from the first radio transceiver device; and
communicate with the first radio transceiver device over the radio propagation channel and via the at least one meta-surface whilst applying the initial uplink transmission parameters that correspond to the selected activation setting.

32. (canceled)
